(19) United States
(12) Patent Application Publication
(10) Pub. No.: US 2019/0359525 A1
(43) Pub. Date: Nov. 28, 2019

(54) STRUCTURAL ELEMENTS HAVING POND ASH

(71) Applicant: Sridhar NADAVI, Vishal Nagar, Bellary (IN)

(72) Inventor: Sridhar NADAVI, Vishal Nagar, Bellary (IN)

(21) Appl. No.: 16/464,269

(22) PCT Filed: Jul. 31, 2017
(86) PCT No.: PCT/IN2017/050316

§ 371 Date: May 26, 2019

(30) Foreign Application Priority Data
Apr. 18, 2017 (IN) 201741013734

(51) Int. Cl. C04B 18/06; C04B 28/04; C04B 28/08

(52) U.S. Cl. CPC C04B 18/06; C04B 2111/40; C04B 28/08; C04B 28/04

(57) ABSTRACT

The invention provides a method for obtaining a structural element having pond ash. The method includes selecting a pond ash and adding cement to the pond ash to obtain a first mixture. Foam is sprayed to the first mixture and the said mixture is then mixed with water to form a foam concrete. The foam concrete thus obtained is then poured into a mould to obtain the desired structural element.

### FIELD OF INVENTION

The invention generally relates to the field of civil engineering and particularly to a method for obtaining a concrete from pond ash that can be used for creating various structural elements.

### BACKGROUND

Pond ash is a residue arising from burning of coal, predominantly in thermal power plants. The residue is deposited in a created pond and hence acquires the name pond ash. The pond ash thus deposited is a pozzolonic material rich in silica and calcium content. However, the pond ash thus obtained has high porosity and has high rate of water absorption. It is known that pond ash can be a good substitute for sand in obtaining concrete. There have been methods known to exist in the prior art that have utilized pond ash for obtaining concrete. One such method is disclosed in U.S. Pat. No. 4,040,852 assigned to Amax Resource Recovery Systems Inc. The method includes selecting dry pond ash being essentially free of fly ash and other excess fine particles so that no more than 25 percent passes a 100-mesh screen, and having less than 1 percent iron pyrite by weight and not more than 5 percent sulfur trioxide by weight. The selected dry pond ash is then mixed along with Portland cement to be used in concrete. The '852 patent only teaches to use the pond ash as a light weight aggregate for preparation of concrete. Further, there is a restriction on the mesh size.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows variation of compression strength of the foam concrete obtained, with number of days of curation, according to an embodiment of the invention.

### SUMMARY OF THE INVENTION

One aspect of the invention provides a method for obtaining a structural element having pond ash. The method includes selecting a pond ash and adding cement to the pond ash to obtain a first mixture. Foam is sprayed to the first mixture and the said mixture is then mixed with water to form a foam concrete. The foam concrete thus obtained is then poured into a mould to obtain the desired structural element.

Another aspect of the invention provides structural elements having pond ash.

### DETAILED DESCRIPTION OF THE INVENTION

Various embodiments of the invention provide a method for obtaining a structural element having pond ash. Initially a predefined concentration of the pond ash is selected. The pond ash is also referred to a bottom ash, in the art, and is used herein interchangeably without altering the meaning or interpretation. The concentration of the pond ash is in the range of about 20% W/V to about 40% W/V of the total mixture. The source of pond ash is predominantly the residue from a thermal power plant. The pond ash obtained is in the wet form. The wet pond ash is then subjected to a step of drying by any of the known methods of drying. The dried pond ash is then used in the further process.

Table 1 shows sieve analysis of the pond ash obtained, according to an embodiment of the invention.

| | | | | Specification as per IS: 383-2016 | | | |
|---|---|---|---|---|---|---|---|
| | | | | for Fine Aggregate | | | |
| | | Cumulative | | (Percentage passing) | | | |
| IS Sieve | | Percent Retained | | Zone- | Zone- | Zone- | Zone- |
| Designation | | Passing | | I | II | III | IV |
| 10.00 | mm | 0 | 100 | 100 | 100 | 100 | 100 |
| 04.75 | mm | 0 | 100 | 90-100 | 90-100 | 90-100 | 95-100 |
| 02.36 | mm | 0 | 100 | 60-95 | 75-100 | 85-100 | 95-100 |
| 01.18 | mm | 0.8 | 99.2 | 30-70 | 55-90 | 75-100 | 90-100 |
| 600 | microns | 4.9 | 95.1 | 15-34 | 35-59 | 60-79 | 80-100 |
| 300 | microns | 22.5 | 77.5 | 5-20 | 8-30 | 12-40 | 15-50 |
| 150 | microns | 66.7 | 33.3 | 0-10 | 0-10 | 0-10 | 0-15 |

The sieve analysis shows that the percentage of the pond ash retained increases with the decrease in the sieve dimension. Preferably, the filler material should have maximum percentage retained for sieve designation less than 600 microns. The pond ash shows 70% retention at 150 microns and hence makes it suitable as a filler material for foam concrete.

The dried pond ash obtained is then mixed with a predefined concentration of cement to obtain a first mixture. Examples of cement include but are not limited to Portland cement, white cement, slag cement and cementitious material. The concentration of the cement is in the range of about 10% W/V to about 20% W/V of the total mixture. The first mixture is then sprayed with foam. Examples of foam includes but is not limited to class of protein based foaming agents and class of synthetic foaming agents. The concentration of the foam, selected for spraying, is in the range of about 40% W/V to about 70% W/V of the total mixture.

The foam sprayed mixture is then mixed with water. Amount of water added to the foam sprayed mixture depends on the quantity of cement added. In one embodiment of the invention, the amount of water added is calculated as ratio of water to cement added. In one example of the invention, the water to cement ratio is in the ratio of about 1:2.5. The range of water to cement ratio can be in the range of about 1:2 to about 1:4. Water is continuously added and mixed for about 4 minutes to about 6 minutes. Subsequent to the addition of water for the said duration of time, a foam concrete is obtained. The foam concrete obtained is then poured into a mould of desirous shape and configuration to obtain a structural element. Examples of structural elements include but are not limited to a brick, a board, a conduit, a beam, a basin, a column, drywall, a tile, a fiber siding, a slab, an acoustic barrier, or an insulation. The mould selected is dependent on the structural element to be formed.

The foam concrete thus obtained is then subjected to physical and chemical characterisation. Physical characterisation includes but is not limited to estimation of density, determination of compression strength. Table 2 shows compression strength analysis of the foam concrete obtained and formed as a block, according to one example of the invention.

| | | Size of test | Compressive Strength |
|---|---|---|---|
| Sl No | Identification | specimen (mm) | (N/(mm)\hat{ }2) |
| 1 | 1 | 150 × 150 × 150 | 3.7 |
| 2 | | 150 × 150 × 150 | 3.5 |
| 3 | | 150 × 150 × 150 | 2.4 |
| 4 | 2 | 150 × 150 × 150 | 2.0 |
| 5 | | 150 × 150 × 150 | 1.9 |
| 6 | | 150 × 150 × 150 | 1.8 |
| 7 | 3 | 96 × 100 × 98 | 1.9 |
| 8 | | 94 × 98 × 98 | 1.6 |
| 9 | | 95 × 98 × 97 | 1.7 |

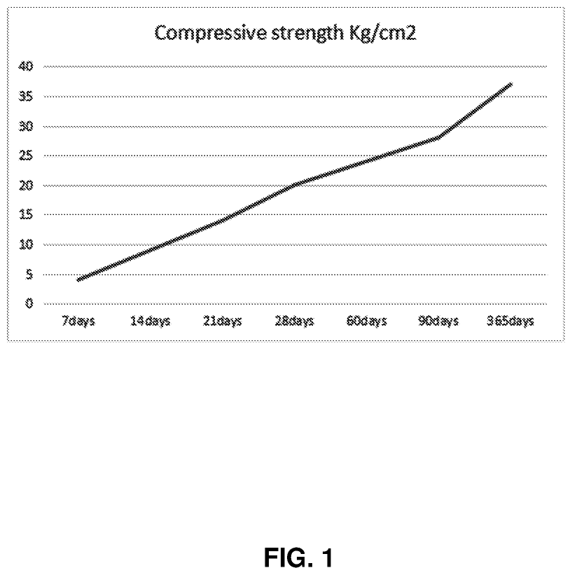

FIG. 1 shows variation of compression strength of the foam concrete obtained, with number of days of curation, according to an embodiment of the invention. The compressive strength of the foam concrete obtained is as per the Indian standards for concrete masonry parts, specifically IS2185 part 4.

The density of the foam concrete is in the range of about 500 Kg/CuM to about 1000 Kg/CuM.

Chemical characterisation include but is not limited to percentage composition analysis of constituents of the foam concrete. The percentage of Carbon dioxide, CO₂ present in the pond ash is about 0.34%. The percentage of Calcium Oxide CaO is about 2.8%. CAO is low and good for lime reactivity in the foam concrete.

Another embodiment of the invention provides a structural element from pond ash. The structural element obtained includes about 20% W/V to about 40% W/V pond ash, about 10% W/V to about 20% W/V cement, about 40% W/V to about 70% W/V foam, and water in the ratio of about 1:2 to about 1:4 with respect to cement. The foam concrete obtained is then poured into a mould of desirous shape and configuration to obtain a structural element. Additionally, fibres are added to increase the strength and tenacity of the structural element. Examples of Fibres include but are not limited to synthetic and steel fibers. Examples of structural elements include but are not limited to a brick, a board, a conduit, a beam, a basin, a column, drywall, a tile, a fiber siding, a slab, an acoustic barrier, or an insulation. The mould selected is dependent on the structural element to be formed.

### Example 1: Formation of Bricks

The foam concrete obtained according to the method as described herein is poured into a mould of desired shape and configuration to obtain a structural element. The mould is configured to have a shape of a desired dimension. The foam concrete obtained is poured into the mould and allowed for setting for a time duration in the range of about 24 hours to about 36 hours. Subsequent to the setting, the mould is separated from the formed brick and is then subjected to curing. In one example the curing process includes spraying of water for 21 days. The spraying is a regulated spraying for a pre-determined duration of time. Alternatively, the curing can be achieved by humidification or any such method that enables slow and regulated cooling of the formed brick, as obvious to a person skilled in the art. The formed brick is then allowed to dry for a duration of about 7 days to about 10 days.

### Example 2: Formation of Panels

The foam concrete obtained according to the method as described herein is poured into a mould capable of forming a pre-cast panel. Examples of sizes of mould for forming a panel include but is not limited to 600×2400×50, 600×2400×75 & 600×2400×100 mm. The foam concrete obtained is poured into the mould and allowed for setting for a time duration in the range of about 24 hours to about 36 hours. The structural element is providing with male and female edges for a stable bonding. Subsequent to the setting, the mould is separated from the formed panel and is then subjected for curing. In one example the curing process includes spraying of water for 21 days. The spraying is a regulated spraying for a pre-determined duration of time. Alternatively, the curing can be achieved by humidification or any such method that enables slow and regulated cooling of the formed panel, as obvious to a person skilled in the art.

The invention provides a method for forming a foam concrete using pond ash. The foam concrete thus formed is capable of forming structural elements. One distinct advantage of the invention is the structural element formed is light weight with densities in the range of 500 Kg/CuM to about 1000 Kg/CuM. The compressive strength of the light weight structural element is significantly high. Further the structural element formed utilizes 20% less cement compared to the conventional structural elements formed. The foregoing description of the invention has been set merely to illustrate the invention and is not intended to be limiting. Since modifications of the disclosed embodiments incorporating the spirit and substance of the invention may occur to person skilled in the art, the invention should be construed to include everything within the scope of the appended claims and equivalents thereof.

I claim:

1. A method for obtaining a structural element having pond ash, the method comprising:
selecting a predefined concentration of the pond ash;
adding a predefined concentration of cement to the pond ash to obtain a first mixture;
spraying a predefined concentration of a foam to the first mixture to obtain a second mixture;
mixing the second mixture in water for a pre-determined duration of time to obtain a foam concrete; and
incorporating the foam concrete into a predetermined mould to obtain the structural element.

2. The method of claim 1, wherein the concentration of the pond ash is in the range of about 20% W/V to about 40% W/V of the total mixture.

3. The method of claim 1, wherein the concentration of the cement is in the range of about 10% W/V to about 20% W/V of the total mixture.

4. The method of claim 1, wherein the concentration of the foam is in the range of about 40% W/V to about 70% W/V of the total mixture.

5. The method of claim 1, wherein the pond ash is obtained as a byproduct from burning of coal.

6. The method of claim 1, wherein the foam is selected from a group comprising of a protein based foaming agent or a synthetic foaming agent.

7. The method of claim 1, wherein the cement is selected from a group comprising of Portland cement, white cement, slag cement and cementitious material.

8. The method of claim 1, wherein the ratio of second mixture to water is in the range of about 1:1 to about 1:2.

9. The method of claim 1, wherein the pre-determined duration of time is in the range of about 4 minutes to about 6 minutes.

10. The method of claim 1, wherein the mould is dependent on the structural element to be formed.

11. The method of claim 1, wherein the structural element obtained is at least one of a brick, a board, a conduit, a beam, a basin, a column, drywall, a tile, a fiber siding, a slab, an acoustic barrier, or an insulation.

12. A structural element having pond ash, wherein the structural element comprises of:
about 20% W/V to about 40% W/V pond ash;
about 10% W/V to about 20% W/V cement;
about 40% W/V to about 70% W/V foam; and
water, wherein the water to cement ratio is in the ratio of about 1:2 to about 1:4.

13. The structural element of claim 12, wherein the pond ash is obtained as a byproduct of burning of coal.

14. The structural element of claim 12, wherein the cement is selected from a group comprising of Portland cement, white cement, slag cement and cementitious material.

15. The structural element of claim 12, wherein the foam is selected from a group comprising of a protein based foaming agent or a synthetic foaming agent.

16. The structural element of claim 12, wherein the structural element formed is at least one of a brick, a board, a conduit, a beam, a basin, a column, drywall, a tile, a fiber siding, a slab, an acoustic barrier, or an insulation.

17. The structural element of claim 12, wherein the density of the structural element is in the range of about 500 Kg/CuM to about 1000 Kg/CuM.
